(19) United States
(12) Patent Application Publication
(10) Pub. No.: US 2011/0051693 A1
(43) Pub. Date: Mar. 3, 2011

(54) METHOD AND APPARATUS FOR ROAMING SEAMLESSLY

(75) Inventors: CHIA HSIANG HSU, HSINCHU COUNTY (TW); TSUNG YUAN PAN, HSINCHU COUNTY (TW)

(73) Assignee: RALINK TECHNOLOGY CORPORATION, HSINCHU COUNTY (TW)

(21) Appl. No.: 12/862,997

(22) Filed: Aug. 25, 2010

(30) Foreign Application Priority Data
Aug. 31, 2009 (TW) 098129205

(51) Int. Cl. H04W 4/00

(52) U.S. Cl. 370/332

(57) ABSTRACT

In accordance with the invention, a method for roaming seamlessly comprises the steps of: associating with a first access point; selecting a second access point if a first received signal strength indication (RSSI) value is less than a first threshold value; performing an authentication procedure and a handshaking procedure with the second access point; and associating with the second access point if a second RSSI value is less than a second threshold value.

### BACKGROUND OF THE INVENTION

1. Field of the Invention

The present invention relates to a communication system, and more particularly, to a method and apparatus for roaming seamlessly.

2. Description of the Related Art

Wireless local area network (WLAN) technology is now widely used in various applications. Numerous organizations devote extensive resources to research seeking improvements in WLAN data communication quality. In a WLAN, a wireless transmit/receive unit (WTRU) may be located within communication range of several access points (APs). When the WTRU roams among various APs, the AP with which the WTRU associates may be switched in accordance with a location of the WTRU and the signal quality.

In order to ensure service quality for WLAN applications, some requirements for transmission of packets are defined. For example, for voice over IP (VoIP) services, acceptable network transmission environments with good packet data processing performance ensure that the packet delay is less than 150 ms. Slower packet transmission rates cause echoes and tremolos caused by delays of packets, and thus longer delays will cause poor sound quality for users. According to the IEEE 802.11r standard, the switching time for a roaming WTRU from one AP to another AP is required to be less than 50 ms to maintain the quality of VOIP services in a wireless network. Therefore, finding ways to complete related procedures for roaming in advance to decrease the delay caused by an AP switching operation is an important issue for the market.

### SUMMARY OF THE INVENTION

A method and apparatus for roaming seamlessly determine whether an authentication procedure and a handshaking procedure are performed in advance to obtain a key which is needed for data transmissions in accordance with received signal strength indication (RSSI) values of the AP with which the apparatus associates. During the processes of performing the authentication procedure and the handshaking procedure for the next AP, the apparatus continues to transceive data to/from the AP with which the apparatus currently associates. The conditions for switching are set by a user. For example, when an RSSI value of the AP with which the apparatus associates is less than a threshold value set by a user, the apparatus is switched to associate with another AP.

One embodiment of the present invention discloses a method for roaming seamlessly, comprising the steps of: associating with a first access point; selecting a second access point if a first RSSI value of the first access point is less than a first threshold value; performing an authentication procedure and a handshaking procedure with the second access point; and associating with the second access point if a second RSSI value of the first access point is less than a second threshold value.

Another embodiment of the present invention discloses a method for roaming seamlessly, comprising the steps of: associating with a first access point; performing a channel scanning procedure if a first RSSI value of the first access point is less than a first threshold value; generating a candidate list in accordance with the channel scanning procedure; selecting a second access point in accordance with the candidate list; performing an authentication procedure and a handshaking procedure with the second access point; and associating with the second access point if a second RSSI value of the first access point is less than a second threshold value.

Another embodiment of the present invention discloses an apparatus for roaming seamlessly comprising a forwarding unit, a receiving unit, a determining unit, a selecting unit, an authenticating/handshaking unit and a switching unit. The forwarding unit is utilized to forward a plurality of packets to a first access point or a second access point. The receiving unit is utilized to receive a plurality of packets forwarded from the first access point or the second access point. The determining unit is utilized to determine whether at least one RSSI value of the first access point is less than a first threshold value or less than a second threshold value. The selecting unit is utilized to select the second access point in accordance with at least one candidate list and a first determining result of the determining unit. The authenticating/handshaking unit is utilized to perform an authentication procedure and a handshaking procedure with the second access point. The switching unit is utilized to switch a connection to the second access point in accordance with a second determining result of the determining unit.

### BRIEF DESCRIPTION OF THE DRAWINGS

The invention will be described according to the appended drawings in which:

FIG. 1 illustrates a circumstance in which a station roams from the communication range of one AP to the communication range of another AP;

FIG. 2 shows a flowchart of a method for roaming seamlessly in accordance with an exemplary embodiment of the present invention;

FIG. 3 shows a flowchart of a method for roaming seamlessly in accordance with another exemplary embodiment of the present invention; and

FIG. 4 illustrates a block diagram of an apparatus for roaming seamlessly in accordance with another exemplary embodiment of the present invention.

### PREFERRED EMBODIMENT OF THE PRESENT INVENTION

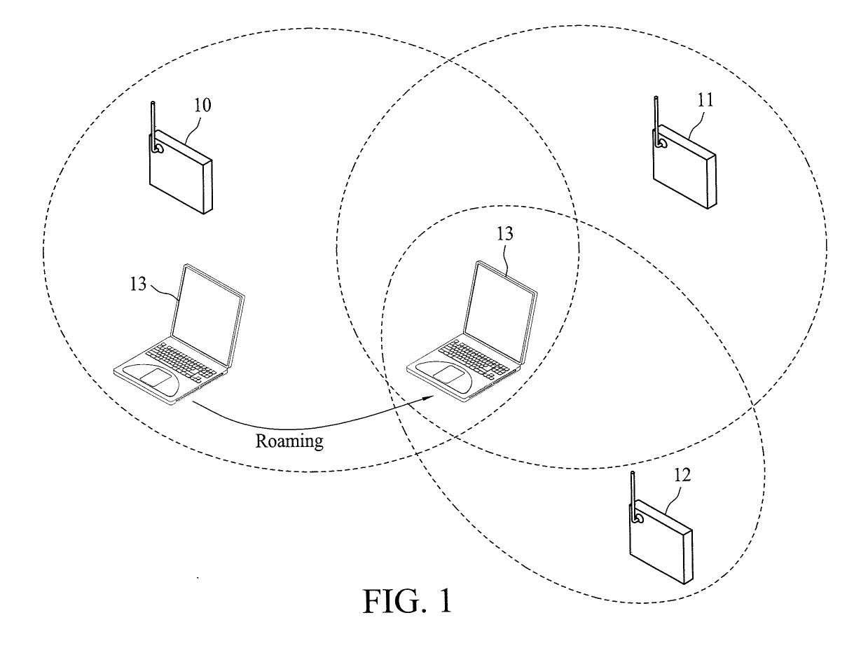

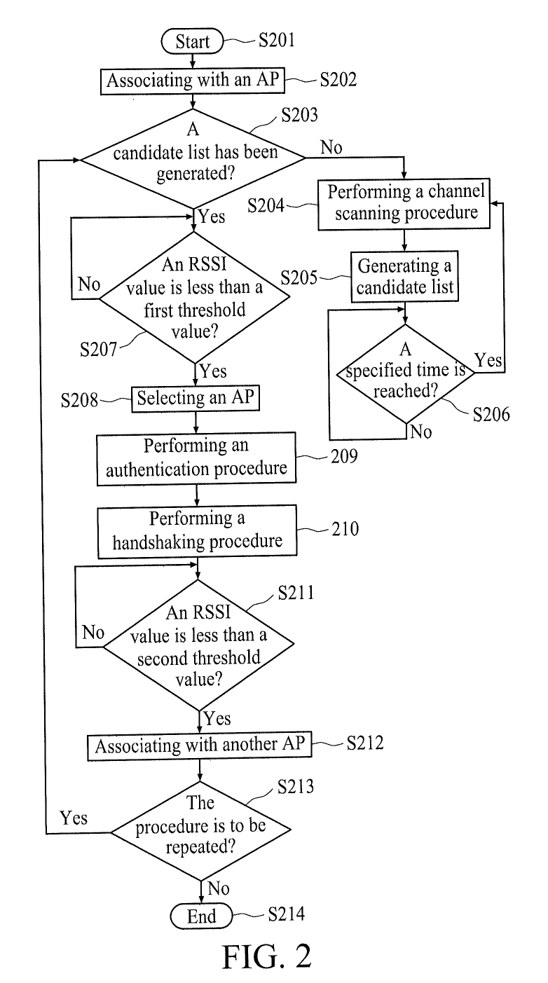

FIG. 1 illustrates a circumstance in which a station 13 roams from the communication range of an AP 10 to the communication ranges of an AP 11 and an AP 12. FIG. 2 shows a flowchart of a method for roaming seamlessly in accordance with an exemplary embodiment of the present invention. In order to enable those skilled in the art to practice the present invention in accordance with the exemplary embodiment, FIG. 1 and FIG. 2 are utilized to describe a procedure of the method for roaming seamlessly. The above-mentioned AP 10, AP 11, AP 12 and station 13 all comply with IEEE 802.11 standards.

In step S201, the procedure of the exemplary embodiment is activated. In step S202, the station 13 is associated with the AP 10. Step S203 determines whether a candidate list has been generated. If NO, a channel scanning procedure is performed in step S204. According to the IEEE 802.11 standard, the scanning phase scans all channels in order to determine which channels can be utilized by a station. The two currently available modes for scanning are active scanning and passive scanning. For active scanning, a station selects a channel and sends a broadcast probe request frame and then waits for a predetermined period of time. If no probe response frame is transmitted by the AP(s) in response to the probe request frame within the predetermined period of time, the station selects a next channel and repeats the procedure. For passive scanning, a station simply goes to the channel of interest and passively listens for any periodic beacon frames sent out by AP(s). If no periodic beacon frame is transmitted by the AP(s) within a predetermined period of time, the station selects a next channel and repeats the passive scanning operation. In step S205, a candidate list is generated in accordance with the channel scanning procedure. Subsequently, a specified time is set by a user and a time counting procedure is performed. Step S206 determines whether the elapsed time of the time counting procedure reaches the specified time. The specified time can be set to 30 seconds, for example. If the specified time is reached, the process is returned to step S204. Steps S204-S206 are utilized to perform a channel scanning procedure periodically. If a candidate list has been generated, step S207 determines whether a received signal strength indication (RSSI) value of the AP 10 associated with the station 13 is less than a first threshold value. In accordance with the exemplary embodiment, the candidate list includes the AP 10, the AP 11 and the AP 12. In accordance with the exemplary embodiment, service set identifiers (SSID) of the AP 10, the AP 11 and the AP 12 are the same. If step S207 returns a result of YES, an AP is selected in accordance with the candidate list in step S208. In accordance with the exemplary embodiment, the AP with the highest RSSI value is selected. The selected AP is the AP 11, for example. Thus, the AP 11 is selected in step S208. In step S209, an authentication procedure is performed. The authentication procedure is an open system authentication procedure, an extensible authentication protocol procedure or a shared-key authentication protocol procedure. In step S210, a handshaking procedure is performed to obtain a key which is needed for data transmissions, wherein the handshaking procedure is a four-way handshaking procedure or a two-way handshaking procedure. Step S211 determines whether an RSSI value of the AP 10 associated with the station 13 is less than a second threshold value. If YES, the station 13 is switched to associate with the AP 11 in step S211. Step S213 determines whether the procedure is to be repeated. If YES, the process is returned to step S203. If NO, the procedure is ended in step S214.

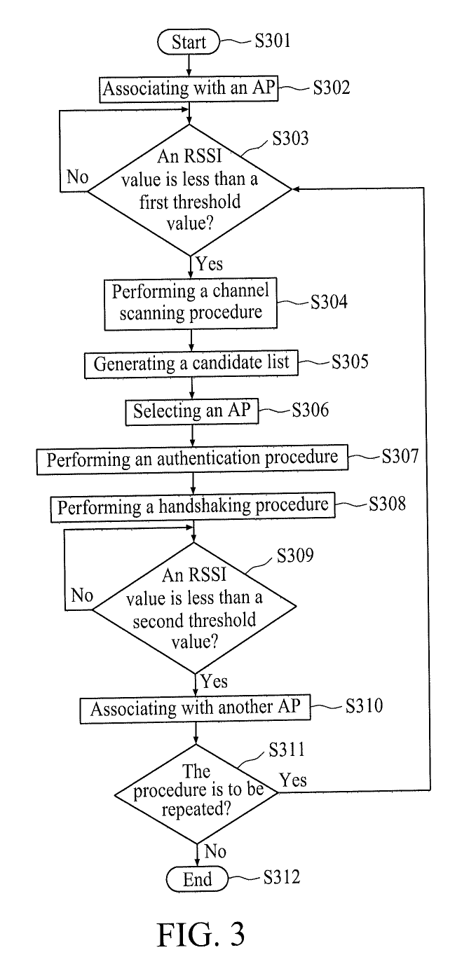

FIG. 3 is a flowchart of a method for roaming seamlessly in accordance with another exemplary embodiment of the present invention. In order to enable those skilled in the art to practice the present invention in accordance with the exemplary embodiment, FIG. 1 and FIG. 3 are utilized to describe the procedure of a method for roaming seamlessly. In step S301, the procedure of the exemplary embodiment is activated. In step S302, a station 13 is associated with an AP 10. Step S303 determines whether an RSSI value of the AP 10 associated with the station 13 is less than a first threshold value. If YES, a channel scanning procedure is performed in step S304. The mode of the channel scanning procedure can be an active scanning mode or a passive scanning mode. In step S305, a candidate list is generated in accordance with the channel scanning procedure. In accordance with the exemplary embodiment, the candidate list includes the AP 10, an AP 11 and an AP 12. In accordance with the exemplary embodiment, SSIDs of the AP 10, the AP 11 and the AP 12 are the same. In step S306, an AP is selected in accordance with the candidate list. In accordance with the exemplary embodiment, the AP with the highest RSSI value is selected. The AP with the highest RSSI value is the AP 11, for example. Thus, the AP 11 is selected in step S306. In step S307, an authentication procedure is performed. The authentication procedure is an open system authentication procedure, an extensible authentication protocol procedure or a shared-key authentication protocol procedure. In step S308, a handshaking procedure is performed to obtain a key which is needed for transmissions, wherein the handshaking procedure is a four-way handshaking procedure or a two-way handshaking procedure. Step S309 determines whether an RSSI value of the AP 10 associated with the station 13 is less than a second threshold value. If YES, the station 13 is switched to associate with the AP 11 in step S310. Step S311 determines whether the procedure is to be repeated. If YES, the process is returned to step S303. If NO, the procedure is ended in step S312.

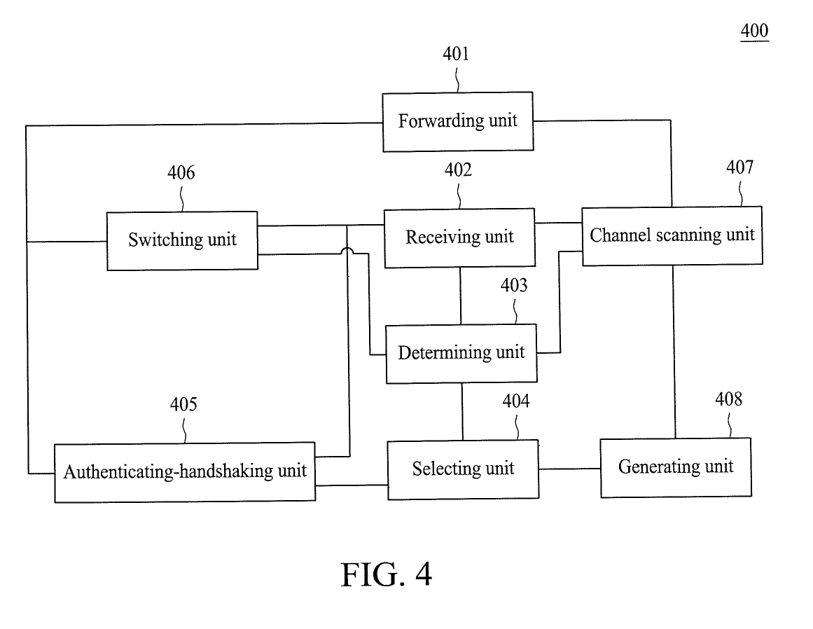

FIG. 4 illustrates a block diagram of an apparatus for roaming seamlessly in accordance with another exemplary embodiment of the present invention. FIG. 1 and FIG. 4 are utilized to describe the embodiment. The apparatus 400 for roaming seamlessly comprises a forwarding unit 401, a receiving unit 402, a determining unit 403, a selecting unit 404, an authenticating/handshaking unit 405, a switching unit 406, a channel scanning unit 407 and a generating unit 408, wherein a station 13 is equipped with the apparatus 400 for roaming seamlessly. Assume that the station 13 has been associating with an AP 10. The forwarding unit 401 is utilized to forward a plurality of packets to the AP 10 while the receiving unit 402 is utilized to receive a plurality of packets forwarded from the AP 10. The apparatus 400 roams from the communication range of an AP 10 to the communication ranges of an AP 11 and an AP 12. The determining unit 403 is utilized to determine whether RSSI values of the AP 10 at various time points are less than a first threshold value or less than a second threshold value. The channel scanning unit 407 is utilized to perform a channel scanning procedure periodically or perform the channel scanning procedure in accordance with a determining result of the determining unit 403. The generating unit 408 is utilized to generate a candidate list in accordance with at least one scanning result of the channel scanning unit 407. In accordance with the exemplary embodiment, the candidate list selectively includes the AP 10, the AP 11 and the AP 12. In accordance with the exemplary embodiment, SSIDs of the AP 10, the AP 11 and the AP 12 are the same. The selecting unit 404 is utilized to select an AP in accordance with another determining result of the determining unit 403. In accordance with the exemplary embodiment, the AP with the highest RSSI value is selected. The AP with the highest RSSI value is the AP 11, for example. The authenticating/handshaking unit 405 is utilized to perform an authentication procedure and a handshaking procedure with the AP 11. The authentication procedure is an open system authentication procedure, an extensible authentication protocol procedure or a shared-key authentication protocol procedure. The handshaking procedure is a four-way handshaking procedure or a two-way handshaking procedure. The authenticating/handshaking unit 405 receives packets from the AP 11 and forwards packets to the AP 11 through the forwarding unit 401 and the receiving unit 402, respectively, to complete the authentication procedure and the handshaking procedure. In the meantime, the forwarding unit 401 forwards packets to the AP 10 while the receiving unit 402 receives packets from the AP 10. In other words, while forwarding and receiving normal communication packets to and from the AP 10, the forwarding unit 401 and the receiving unit 402 simultaneously forwards and receives, respectively, authentication and handshaking packets to and from the AP 11, to complete the authentication procedure and the handshaking procedure. In accordance with an exemplary embodiment of the present invention, the functions of the above-mentioned forwarding unit 401 and the receiving unit 402 can be achieved by providing two instance layers. The switching unit is utilized to switch the apparatus 400 to associate with the AP 11 in accordance with another determining result of the determining unit 403. The above-mentioned apparatus 400 for roaming seamlessly can be implemented with software, firmware, hardware, or a platform with a single processor or with multiple processors.

In accordance with the present invention, a method and apparatus for roaming seamlessly determine whether an authentication procedure and a handshaking procedure are performed in advance to obtain a key which is needed for data transmissions in accordance with RSSI values of the AP with which the apparatus associates. During the processes of performing the authentication procedure and the handshaking procedure for the next AP, the apparatus continues to transceive data to/from the AP with which the apparatus currently associates. The conditions for switching are set by a user. For example, when an RSSI value of the AP with which the apparatus associates is less than a threshold value set by a user, the apparatus is switched to associate with another AP.

The above-described embodiments of the present invention are intended to be illustrative only. Numerous alternative embodiments may be devised by persons skilled in the art without departing from the scope of the following claims.

What is claimed is:

1. A method for roaming seamlessly, comprising:
associating with a first access point;
selecting a second access point if a first received signal strength indication (RSSI) value of the first access point is less than a first threshold value;
performing an authentication procedure and a handshaking procedure with the second access point; and
associating with the second access point if a second RSSI value of the first access point is less than a second threshold value.

2. The method of claim 1, further comprising performing a channel scanning procedure periodically.

3. The method of claim 2, wherein a candidate list is generated in accordance with the channel scanning procedure.

4. The method of claim 3, wherein the second access point is selected in accordance with the candidate list.

5. The method of claim 1, wherein service set identifiers of the first access point and the second access point are the same.

6. The method of claim 1, wherein the authentication procedure is an open system authentication procedure, an extensible authentication protocol procedure or a shared-key authentication protocol procedure.

7. The method of claim 1, wherein the handshaking procedure is a four-way handshaking procedure or a two-way handshaking procedure.

8. A method for roaming seamlessly, comprising:
associating with a first access point;
performing a channel scanning procedure if a first received signal strength indication (RSSI) value of the first access point is less than a first threshold value;
generating a candidate list in accordance with the channel scanning procedure;
selecting a second access point in accordance with the candidate list;
performing an authentication procedure and a handshaking procedure with the second access point; and
associating with the second access point if a second RSSI value of the first access point is less than a second threshold value.

9. The method of claim 8, wherein service set identifiers of the first access point and the second access point are the same.

10. The method of claim 8, wherein the authentication procedure is an open system authentication procedure, an extensible authentication protocol procedure or a shared-key authentication protocol procedure.

11. The method of claim 8, wherein the handshaking procedure is a four-way handshaking procedure or a two-way handshaking procedure.

12. An apparatus for roaming seamlessly, comprising:
a forwarding unit configured to forward a plurality of packets to a first access point or a second access point;
a receiving unit configured to receive a plurality of packets forwarded from the first access point or the second access point;
a determining unit configured to determine whether at least one received signal strength indication value of the first access point is less than a first threshold value or a second threshold value;
a selecting unit configured to select the second access point in accordance with at least one candidate list and a first determining result of the determining unit;
an authenticating/handshaking unit configured to perform an authentication procedure and a handshaking procedure with the second access point; and
a switching unit configured to switch the apparatus to associate with the second access point in accordance with a second determining result of the determining unit.

13. The apparatus of claim 12, further comprising a channel scanning unit, the channel scanning unit being configured to perform a channel scanning procedure periodically or to perform the channel scanning procedure in accordance with a third determining result of the determining unit.

14. The apparatus of claim 13, further comprising a generating unit, the generating unit being configured to generate the candidate list in accordance with at least one scanning result of the channel scanning unit.

15. The apparatus of claim 12, wherein service set identifiers of the first access point and the second access point are the same.

16. The apparatus of claim 12, wherein the authentication procedure is an open system authentication procedure, an extensible authentication protocol procedure or a shared-key authentication protocol procedure.

17. The apparatus of claim 12, wherein the handshaking procedure is a four-way handshaking procedure or a two-way handshaking procedure.

18. The apparatus of claim 12, which is implemented with software, firmware, hardware, or a platform with a single processor or with multiple processors.
